(19) United States
(12) Patent Application Publication
(10) Pub. No.: US 2016/0065405 A1
(43) Pub. Date: Mar. 3, 2016

(54) POLICY-BASED INTELLIGENT AD-HOC NETWORK ARCHITECTURE FOR GROUPING NODES BASED ON COMMON ACTIVITIES

(71) Applicant: Aviacomm Inc., Sunnyvale, CA (US)

(72) Inventors: Hans Wang, Mountain View, CA (US); Shih Hsiung Mo, San Jose, CA (US)

(73) Assignee: AVIACOMM INC., Sunnyvale, CA (US)

(21) Appl. No.: 14/791,005

(22) Filed: Jul. 2, 2015

Related U.S. Application Data
(60) Provisional application No. 62/042,725, filed on Aug. 27, 2014.

(51) Int. Cl. H04L 12/24; H04L 12/751; H04L 12/741; H04W 12/06; H04B 7/14; H04W 56/00

(52) U.S. Cl. CPC H04L 41/04; H04B 7/14; H04W 56/001; H04L 45/745; H04W 12/06; H04L 45/02; H04W 84/18

(57) ABSTRACT

An ad-hoc network can create a private activity-based network for nodes associated with a common activity. A network node of the ad-hoc network can include a first radio for communicating with other network nodes of the ad-hoc network, a second radio for relaying data packets across the ad-hoc network, and a third radio for synchronizing network topology information with a respective network node of the one or more neighboring nodes. Specifically, the first, second, and third radios are different radios that operate concurrently. These three separate radios allow the network node to communicate with other network nodes using the second radio while using the third radio to discover changes to the ad-hoc network topology, and/or to synchronize an updated network topology with other neighboring nodes.

### RELATED APPLICATION

This application claims the benefit of U.S. Provisional Application No. 62/042,725, Attorney Docket Number AVC14-1001PSP, entitled “POLICY BASED INTELLIGENT AD HOC NETWORK ARCHITECTURE FOR A GROUP OF NODES WITH COMMON INTEREST,” by inventors Hans Wang and Shih Hsiung Mo, filed 27 Aug. 2014.

### BACKGROUND

1. Field

This disclosure is generally related to ad-hoc networks. More specifically, this disclosure is related to creating a private activity-based ad-hoc network for network nodes associated with a common activity.

2. Related Art

Ad hoc networks typically include a decentralized wireless network where the member nodes are responsible for forwarding data packets to other members without relying on dedicated routers or access points. These member nodes keep the ad hoc network's topology up to date, and propagate any topology changes to other members of the ad hoc network.

However, updates to the ad hoc network's topology can occur frequently, as nodes move into range or out of range, move to a different neighborhood of the ad hoc network, or go offline or online. Each time a member node updates the network topology, this member node needs to use the updated network topology to update a communication routing table that allows the member node to determine active communication paths between any two nodes in the network.

The member node also needs to share any changes in the topology with the other members of the ad hoc network, which allows the other member nodes to update their corresponding routing tables. Unfortunately, sharing topology information typically requires member nodes to stop using their radios for communicating data packets, and instead use their radios for synchronizing their routing tables with their neighboring nodes.

To make matters worse, some ad hoc networks consists of mobile nodes that frequently move to new physical locations, which require a frequent update to the ad hoc network's routing table. This frequent sharing of routing tables consumes an undesirably large amount of bandwidth, and this bandwidth increases as the number of nodes in the network is large.

### SUMMARY

One embodiment provides an ad hoc network that creates a private activity-based network for network nodes associated with a common activity. A network node of the ad-hoc network can include a first radio for communicating with other network nodes of the ad-hoc network, a second radio for relaying data packets across the ad-hoc network, and a third radio for synchronizing network topology information with a respective network node of the one or more neighboring nodes. Specifically, the first, second, and third radios are different radios that operate concurrently. These three separate radios allow the network node to communicate with other network nodes using the second radio while using the third radio to discover changes to the ad-hoc network topology, and/or to synchronize an updated network topology with other neighboring nodes. For example, the network node can receive network topology information from a respective network node of the one or more neighboring nodes using the third radio. Then, in response to detecting a change to a network topology of the ad-hoc network based on the received network topology information, the network node can update the routing table based on the received network topology information.

In some embodiments, the network topology information can include node information for a neighboring network node, routing information for the neighboring network node, and/or a routing table.

In some embodiments, the network node can synchronize the network topology information between the local network node and the one or more neighboring nodes via the third radio.

In some embodiments, the one or more neighboring nodes can be associated with a common activity with the local network node. Moreover, the network node can manage a private network associated with the common activity, such that the private network includes as members the one or more neighboring nodes associated with the common activity.

In some variations to these embodiments, responsive to detecting a new network node in the ad-hoc network, the network node can authenticate the network node, and verifies that the network node is associated with the common activity. Moreover, the network node can add the network node to the private network responsive to successfully authenticating and verifying the network node.

In some variations to these embodiments, the network node determines a broadcast interval based on a policy for the private network.

In some variations to these embodiments, responsive to determining that the common activity corresponds to a still environment, the network node sets the broadcast interval to above a predetermined slow-beacon interval.

In some variations to these embodiments, responsive to determining that the common activity corresponds to a dynamic environment, the network node sets the broadcast interval to below a predetermined fast-beacon interval.

### BRIEF DESCRIPTION OF THE FIGURES

FIG. 1 illustrates an exemplary ad-hoc network for deploying a private activity-based network in accordance with an embodiment.

FIG. 2 illustrates an exemplary ad-hoc network node that facilitates deploying a private activity-based network in accordance with an embodiment.

FIG. 3 presents a flow chart illustrating a method for using a scan radio to synchronize network-topology with neighboring network nodes of an ad-hoc network in accordance with an embodiment.

FIG. 4 presents a flow chart illustrating a method for adding a network node to an activity-based ad-hoc network in accordance with an embodiment.

FIG. 5 illustrates an exemplary computer system 502 that facilitates deploying a private activity-based network in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide an ad-hoc network which solves the problem of grouping network nodes associated with a common activity into a private activity-based network. Moreover, these network nodes can include a broadcast radio and a scan radio, in addition to a communication radio. The broadcast radio facilitate detecting changes to a node's network neighborhood and synchronizing an updated network topology to its network neighbors, without interrupting data packets being communicated over the communication radio. The scan radio facilitates the network node to relay packets toward their destination node without impacting the local network node's use of the communication radio.

In some embodiments, an organization can assign network-enabled computing devices to its members or employees. These network-enabled devices can include, for example, smartphones, computers (e.g., tablet computers), and/or push-to-talk radios. These devices can communicate with each other over an existing computer network (e.g., a Wi-Fi network), and/or can communicate with each other directly to form an ad-hoc network. In some embodiments, a member of the organization can provide his own network-enabled device, which the organization provisions to allow the member's personal device to communicate with other devices of the organization.

If multiple members of the organization configure their devices for a certain activity, their network-enabled devices can join together to create an activity-based ad-hoc network for that activity. This activity-based network can allow the network-enabled devices to optimize their ad-hoc network for the activity at hand. For example, a city's emergency responders may carry wireless push-to-talk radios that typically communicate only with other radios of the same department. This may be because police officers may only care to communicate with other police officers and their headquarter. Similarly, firemen may only wish to communicate with other firemen, and paramedics may only wish to communicate with other paramedics.

However, in the event of a major emergency such as an airplane crash or a large fire, it may be necessary for these separate emergency-responder groups to communicate with each other so that they can coordinate their joint efforts. Each on-site emergency responder can join the common activity to communicate with any other emergency responder that is aiding in the emergency, for example, by activating an activity-related policy, and/or by entering a code (e.g., a keyword, or location) associated with their common activity. If other emergency responders are patrolling nearby but not participating in combating the emergency, their communication with other emergency responders or with headquarters will not be heard by those emergency responders combating the emergency. Hence, this activity-based ad-hoc network allows all participants of an activity to easily communicate with each other, without incurring interference or information overload from others not associated with the activity.

### Exemplary Ad-Hoc Network

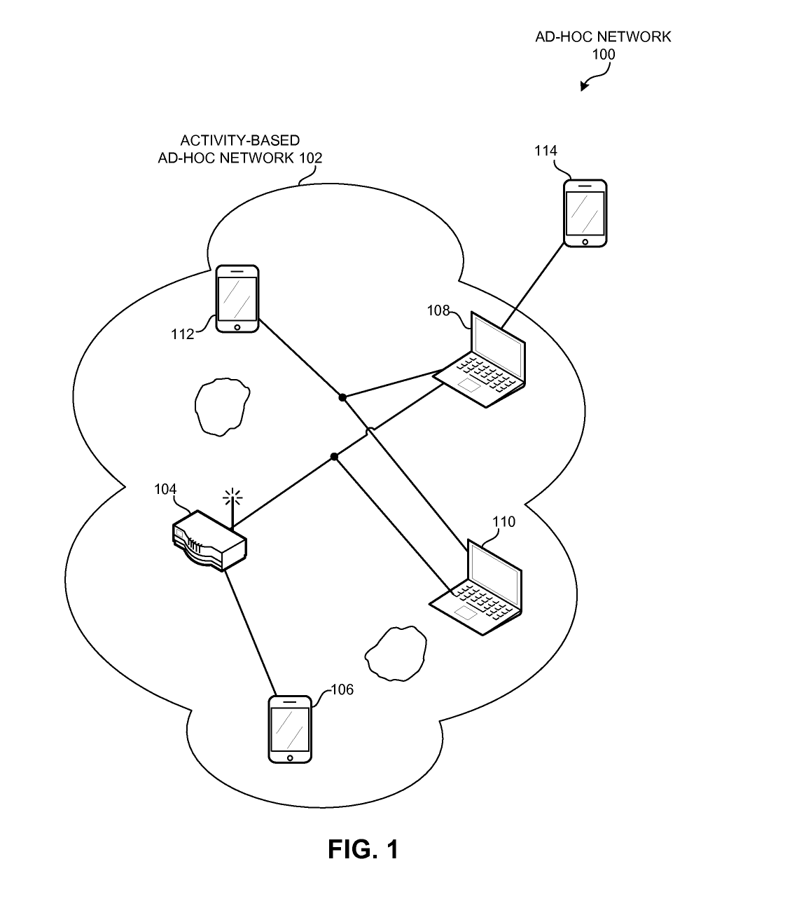

FIG. 1 illustrates an exemplary ad-hoc network 100 for deploying a private activity-based network in accordance with an embodiment. Specifically, ad-hoc network 100 can include a network node 104 which has neighboring network nodes 106, 108, and 110. Network nodes 104, 108, and 110 are one-hop neighbors to each other, whereas network node 106 has a two-hop distance to network nodes 108 and 110. Hence, network node 106 can communicate with network nodes 108 and 110 via network node 104. Moreover, network node 108 can also have neighboring network nodes 110 and 112, which form another group of mutual one-hop neighbors between network nodes 108, 110, and 112.

In some embodiments, a network node 114 can join ad-hoc network 100 when network node 114 reaches a proximity of a member of ad-hoc network 100 (e.g., network node 108). Network node 114 can use a dedicated broadcast radio to advertise itself, and network node 108 can similarly use its local broadcast radio to detect network node 114. These dedicated broadcast radios allow network node 108 to detect new neighboring nodes and synchronize network topology information with other nodes of ad-hoc network 100, without interrupting on-going communication with the other nodes of ad-hoc network 100.

Once network node 108 adds network node 114 to ad-hoc network 100, network node 108 uses the broadcast radio to synchronize the updated network topology information with other nodes of ad-hoc network 100 (e.g., with neighboring network nodes 110 and 112). Network node 108 can also provide the network topology information to network node 114. At this point, network nodes 108, 110, and 112 can be one-hop neighbors to each other. However, network node 114 may only have network node 108 as its neighbor, and so can only communicate with other members of ad-hoc network 100 via network node 108.

In some embodiments, network nodes 104-112 may be associated with a common activity. Hence, network nodes 104-112 may correspond to an activity-based ad-hoc network 102, which network nodes 104-112 formed when initiating and/or joining the common activity. However, if new network node 114 is not associated with this activity, network node 114 may not receive any packets directed to members of activity-based ad-hoc network 102.

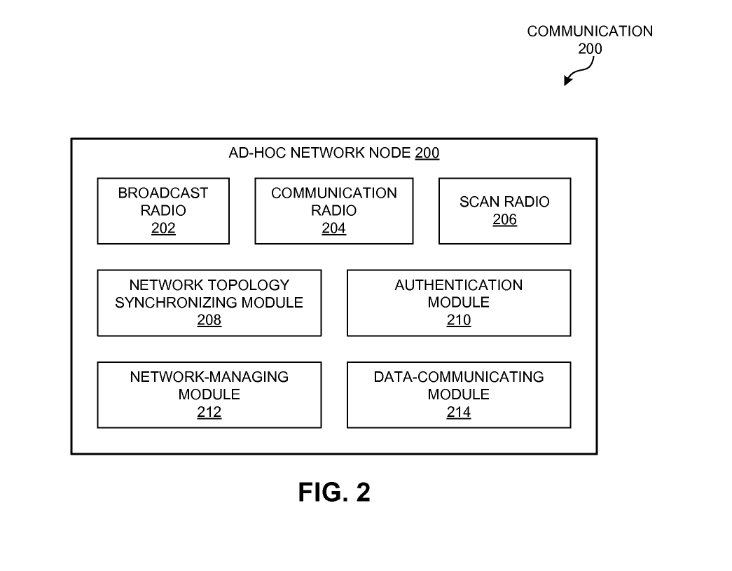

FIG. 2 illustrates an exemplary ad-hoc network node 200 that facilitates deploying a private activity-based network in accordance with an embodiment. Ad-hoc network node 200 can comprise a plurality of modules which may communicate with one another via a wired or wireless communication channel. Ad-hoc network node 200 may be realized using one or more integrated circuits, and may include fewer or more modules than those shown in FIG. 2. Further, ad-hoc network node 200 may be integrated in a computer system, or realized as a separate device which is capable of communicating with other computer systems and/or devices. Specifically, ad-hoc network node 200 can comprise a broadcast radio 202, a communication radio 204, a scan radio 206, a network topology synchronizing module 208, an authentication module 210, a network-managing module 212, and a data-communicating module 214.

In some embodiments, broadcast radio 202 can broadcast data packets to neighboring network nodes of an ad-hoc network, and can receive data broadcasted by its neighboring network nodes. Communication radio 204 can send and/or receive data packets based on a routing table of the ad-hoc network. Scan radio 206 can relay data packets toward their intended destination.

Network topology synchronizing module 208 can use broadcast radio 202 to synchronize the network topology information with neighboring network nodes of the ad-hoc network. In some embodiments, synchronizing module 208 determines a broadcast interval for broadcast radio 202 based on a policy for the private activity-based network. For example, if the common activity corresponds to a still environment, synchronizing module 208 can set the broadcast interval to above a predetermined slow-beacon interval (e.g., 100 milliseconds or higher). Also, if the common activity corresponds to a dynamic environment, synchronizing module 208 can set the broadcast interval to below a predetermined fast-beacon interval (e.g., 100 milliseconds or lower).

Authentication module 210 can authenticate a new neighboring node that has entered the ad-hoc network, and network-managing module 212 can update the network topology information (e.g., the routing table) to add the new neighboring node responsive to successful authentication. Also, if the new neighboring node is associated with an activity, network-managing module 212 can add the new neighboring node to a corresponding activity-based network. Data-communicating module 214 can use communication radio 204 to send or receive data packets to/from a target network node of the ad-hoc network or an activity-based network. In some embodiments, if communication radio 204 receives a packet that is not intended for ad-hoc network node 200, communication module 214 can use scan radio 204 to relay the data packet toward the packet's target network node of the ad-hoc network.

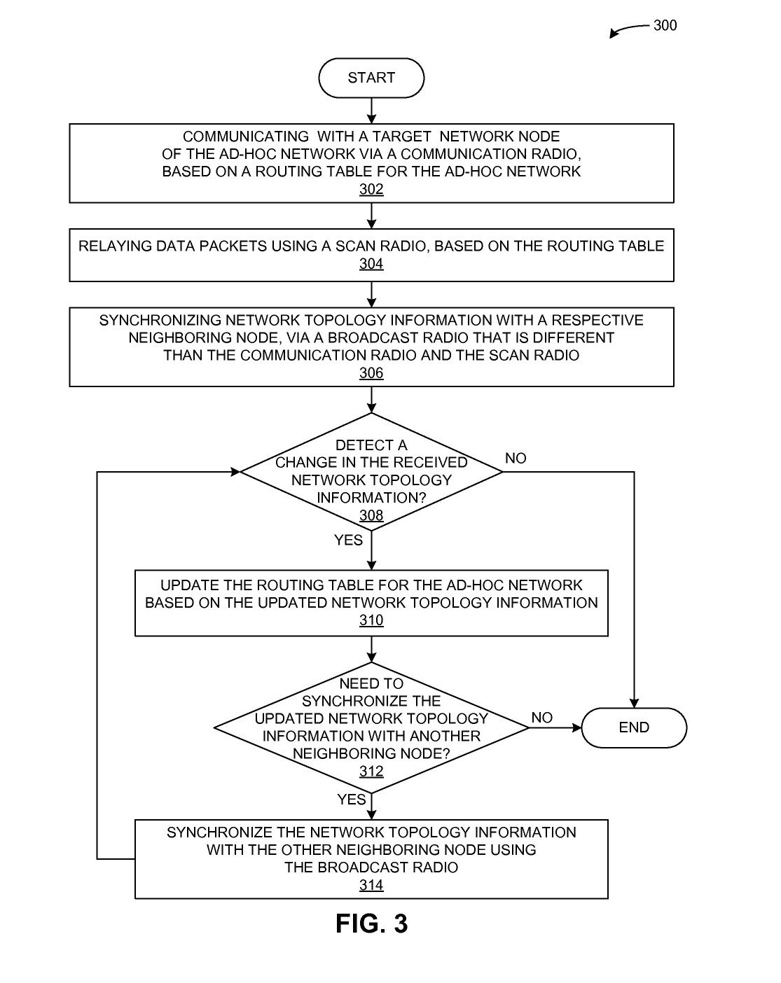

FIG. 3 presents a flow chart illustrating a method 300 for using a broadcast radio to synchronize network-topology with neighboring network nodes of an ad-hoc network in accordance with an embodiment. During operation, the network node can communicate with a target network node using a communication radio, and based on a routing table for the ad-hoc network (operation 302). This routing table can map each network node of the ad-hoc network to a network route which can be used to send or forward a packet to the network node. The local network node can use the routing table by searching for a table entry based on an identifier for the target network node, and reading this table entry to determine the route to use to send the data packets to the target network node. If the target network node is not a neighbor of the local network node, the route may specify a one-hop neighboring node that can forward the data packets to the target network node. The network node can also use a local scan radio to listen for packets that are not intended for the local network node, and to relay these packets toward their intended recipient based on the routing table (operation 304).

Furthermore, the local network node can use the broadcast radio to synchronize network topology information with a neighboring node of the ad-hoc network (operation 306). This synchronized network topology information can include any information about the local network node or the neighboring node, can include network neighborhood information from the local network node or the neighboring node, and/or can include an updated network topology for the ad hoc network (e.g., a routing table). When the local network node uses the broadcast radio to broadcast its local network topology information, any network node within a proximity to the local network node can receive this local network topology information using their local broadcast radio. Specifically, the broadcast radio is different than the communication radio and the scan radio, which allows the local network node to detect new neighboring network nodes regardless if the local network node is communicating with other network nodes using the communication radio or the scan radio.

In some embodiments, when the local network node receives new network topology information, the local network node determines whether it detects a change in the received network topology information (operation 308). This change in network topology information can include, for example, a new network node that has entered the ad-hoc network, a network node that has left the ad hoc network or moved to another neighborhood of the ad hoc network, or an existing network node of the one-hop network vicinity that has new network parameters or performance metrics. For example, the local network node can detect a new network node by receiving network neighborhood information directly from the new network node, or by receiving a routing table (e.g., from an existing neighboring node) that includes routing information, network parameters, and performance metrics to the new network node.

The local network node can also detect a neighboring network node that has left the ad-hoc network, for example, when the local network node does not receive network topology information from the member network node within a predetermined timeout period. As another example, the local network node can determine that a remote network node (e.g., a multi-hop network node) has left the ad-hoc network when the local network node receives new network topology information (e.g., from an existing neighboring node) that no longer includes an entry for the remote network node.

If the local network node does detect a change in the network topology information, the local network node updates its routing table for the ad-hoc network based on the updated network topology information (operation 310). Also, the local network node determines whether it needs to synchronize the updated network topology information with another neighboring node (operation 312), such as a neighboring node which the local network node determines has not received the updated network topology information (e.g., determined based on the routing table). If a neighboring node did not receive the updated network topology information, the local network node proceeds to synchronize the network topology information with this neighboring node using the broadcast radio (operation 314).

It's possible that the local network node may receive another update to the network topology information during the synchronization step of operation 314. Hence, after synchronizing the network topology information, the local network node returns to operation 308 to determine whether it detects another change in the network topology information. If the local network node does not detect a change in the network topology information (operation 308) and does not need to synchronize the network topology information with a neighboring node (operation 312), the method can end.

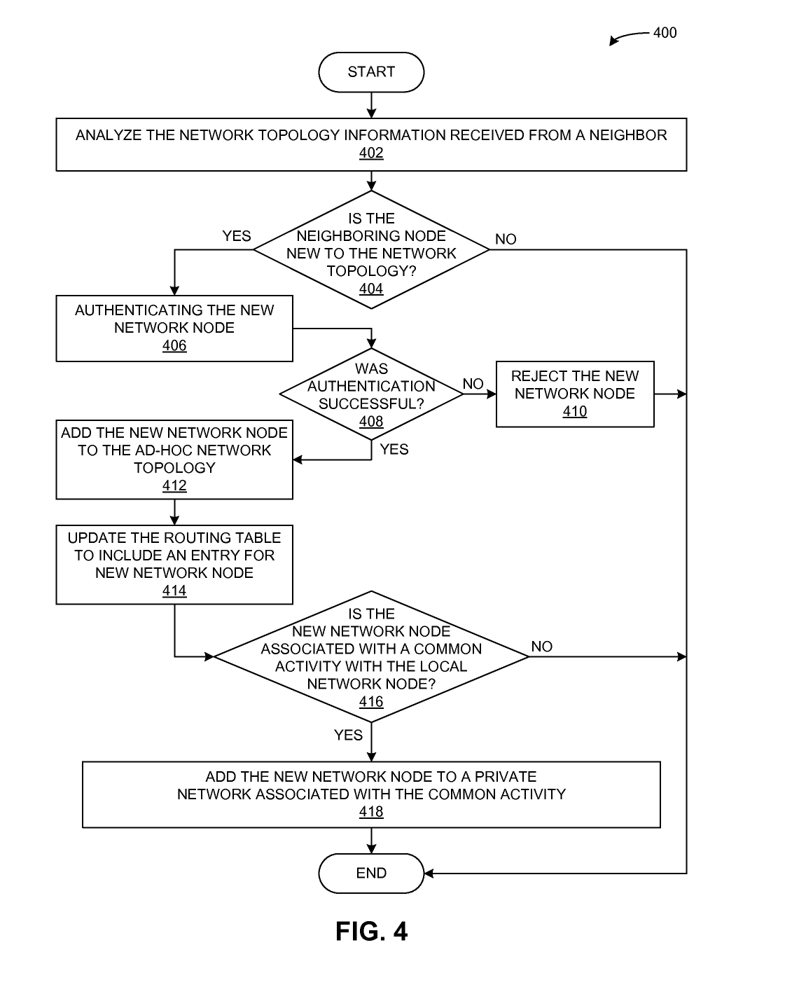

FIG. 4 presents a flow chart illustrating a method 400 for adding a network node to an activity-based ad hoc network in accordance with an embodiment. During operation, the local network node can analyze network topology information received from a nearby network node (operation 402), and determines whether the nearby node is new to the network topology (operation 404). If so, the local network node can authenticate the new network node (operation 406), such as using a digital certificate from the new network node, or using credentials received from the new network node.

The local network node then determines if authentication was successful (operation 408). If authentication is not successful, the local network node rejects the new network node (operation 410), such as by refusing to add the new network node to the ad-hoc network's topology. However, if authentication is successful, the local network node adds the new network node to the ad-hoc network's topology (operation 412), and updates the routing table to include an entry for the new network node (operation 414). In some embodiments, the local network node can proceed to synchronize the updated network topology with other neighboring nodes, for example, using the broadcast radio and/or the scan radio.

In some embodiments, multiple network nodes can create an activity-based network within the ad-hoc network. This activity-based network can include nodes within the ad-hoc network that are associated with a common activity. For example, emergency responders across multiple cities, counties, or states can each carry mobile computing devices or radios that are provisioned to form an ad-hoc network for communicating with each other securely in the event that a central communication network is not available. When emergency responders join together at the event of an emergency, the emergency responders' devices can each search for other nodes of the ad-hoc network that are also associated with the same activity (e.g., the emergency event), and they together form an activity-based network for the common activity.

Hence, regarding the new network node, the local network node can determine whether the new network node is associated with an activity in common with the local network node (operation 416). If so, the local network node proceeds to add the new network node to a private activity-based network associated with the common activity (operation 418).

In some embodiments, this common activity can be represented via an activity keyword, and any network node of the ad-hoc network can join the activity-based network by broadcasting this activity keyword to its neighboring nodes. Alternatively, the activity-based network can be a secure overlay network which requires member nodes to be provisioned ahead of time with a digital certificate and policy for the activity, and can join the activity-based network by presenting this digital certificate to other nodes of the activity-based network.

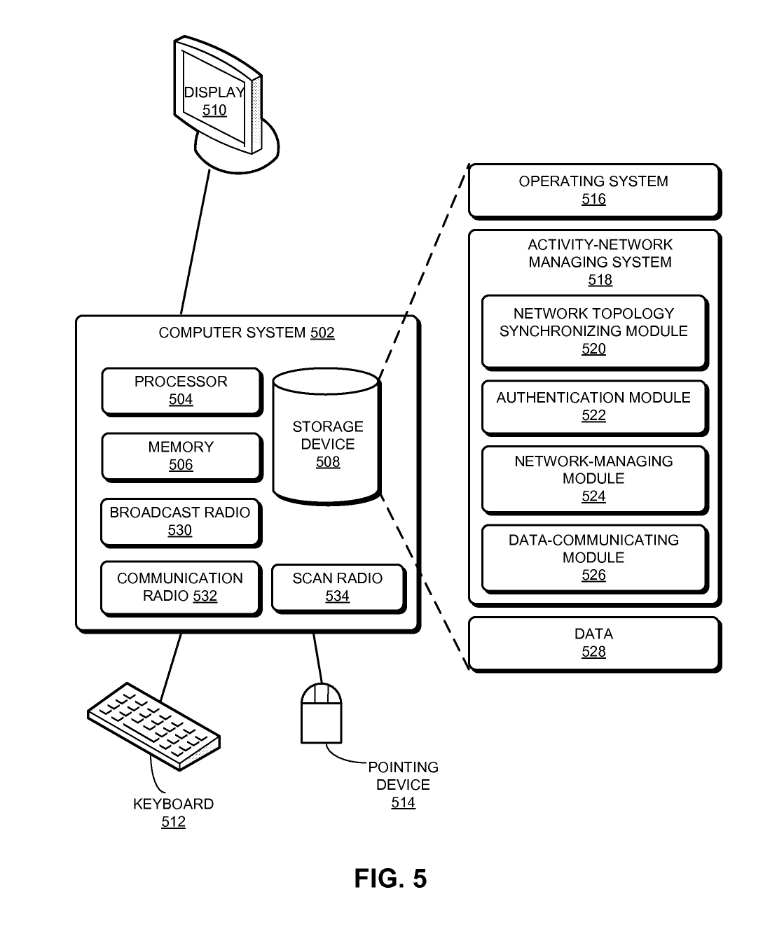

FIG. 5 illustrates an exemplary computer system 502 that facilitates deploying a private activity-based network in accordance with an embodiment. Computer system 502 includes a processor 504, a memory 506, and a storage device 508. Memory 506 can include a volatile memory (e.g., RAM) that serves as a managed memory, and can be used to store one or more memory pools.

Computer system 502 can also include a broadcast radio 530, a communication radio 532, and a scan radio 534. Broadcast radio 530 can broadcast data packets to neighboring network nodes of an ad-hoc network, and can receive data broadcasted by its neighboring network nodes. Communication radio 532 can send and/or receive data packets based on a routing table of the ad-hoc network. Scan radio 534 can relay data packets toward their intended destination. Furthermore, computer system 502 can be coupled to a display device 510, a keyboard 512, and a pointing device 514.

Storage device 508 can store operating system 516, node-managing system 518, and data 526. Node-managing system 518 can include instructions, which when executed by computer system 502, can cause computer system 502 to perform methods and/or processes described in this disclosure.

Specifically, node-managing system 518 may include instructions for using broadcast radio 530 to synchronize the network topology information with neighboring network nodes of the ad-hoc network (network topology synchronizing module 520). Further, node-managing system 518 can include instructions for authenticating a new neighboring node that has entered the ad-hoc network (authentication module 522), and can include instructions for updating the network topology information (e.g., the routing table) to add the new neighboring node responsive to successful authentication (network-managing module 524). Also, if the new neighboring node is associated with an activity, the instructions from network-managing module 524 can add the new neighboring node to a corresponding activity-based network.

Node-managing system 518 can also include instructions for use communication radio 532 to send or receive data packets to/from a target network node of the ad-hoc network or an activity-based network (data-communicating module 526). If communication radio 532 receives a packet that is not intended for computer system 502, data-communicating module 526 can use scan radio 532 to relay the data packet toward the packet's target network node of the ad-hoc network.

Data 526 can include any data that is required as input or that is generated as output by the methods and/or processes described in this disclosure. Specifically, data 526 can store at least network topology information for the ad-hoc network (e.g., a routing table), a policy for an activity-based network, and network topology information for the activity-based network.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
communicating, by a local network node of an ad-hoc network, with a target network node of the ad-hoc network, using a first radio of the local network node, based on a routing table for the ad-hoc network;
relaying a data packet transmitted by a neighboring network node toward the data packet's intended recipient, based on the routing table and using a second radio of the local network node;
synchronizing network topology information with a respective network node of the one or more neighboring nodes using a third radio different than the first and second radios; and
responsive to detecting a change to a network topology of the ad-hoc network based on the received network topology information, updating the routing table based on the received network topology information.

2. The method of claim 1, wherein the network topology information includes one or more of:
node information for a neighboring network node;
routing information for the neighboring network node; and
a routing table.

3. The method of claim 1, further comprising:
synchronizing the network topology information between the local network node and the one or more neighboring nodes via the third radio.

4. The method of claim 1, wherein the one or more neighboring nodes are associated with a common activity with the local network node, and wherein the method further comprises:
managing a private network associated with the common activity, wherein the private network includes as members the one or more neighboring nodes associated with the common activity.

5. The method of claim 4, further comprising:
responsive to detecting a new network node in the ad-hoc network:
authenticating the network node; and
verifying that the network node is associated with the common activity; and
responsive to successfully authenticating and verifying the network node, adding the network node to the private network.

6. The method of claim 4, determining a broadcast interval based on a policy for the private network.

7. The method of claim 6, wherein responsive to determining that the common activity corresponds to a still environment, setting the broadcast interval to above a predetermined slow-beacon interval.

8. The method of claim 6, wherein responsive to determining that the common activity corresponds to a dynamic environment, setting the broadcast interval to below a predetermined fast-beacon interval.

9. A non-transitory computer-readable storage medium storing instructions that when executed by a computer cause the computer to perform a method comprising:
communicating with a target network node of an ad-hoc network, using a first radio of a local network node, based on a routing table for the ad-hoc network;
relaying a data packet transmitted by a neighboring network node toward the data packet's intended recipient, based on the routing table and using a second radio of the local network node;
synchronizing network topology information with a respective network node of the one or more neighboring nodes using a third radio different than the first and second radios; and
responsive to detecting a change to a network topology of the ad-hoc network based on the received network topology information, updating the routing table based on the received network topology information.

10. The storage medium of claim 9, wherein the network topology information includes one or more of:
node information for a neighboring network node;
routing information for the neighboring network node; and
a routing table.

11. The storage medium of claim 9, wherein the method further comprises:
synchronizing the network topology information between the local network node and the one or more neighboring nodes via the third radio.

12. The storage medium of claim 9, wherein the one or more neighboring nodes are associated with a common activity with the local network node, and wherein the method further comprises:
managing a private network associated with the common activity, wherein the private network includes as members the one or more neighboring nodes associated with the common activity.

13. The storage medium of claim 12, wherein the method further comprises:
responsive to detecting a new network node in the ad-hoc network:
authenticating the network node; and
verifying that the network node is associated with the common activity; and
responsive to successfully authenticating and verifying the network node, adding the network node to the private network.

14. The storage medium of claim 12, wherein the method further comprises determining a broadcast interval based on a policy for the private network.

15. The storage medium of claim 14, wherein the method further comprises:
responsive to determining that the common activity corresponds to a still environment, setting the broadcast interval to above a predetermined slow-beacon interval.

16. The storage medium of claim 14, wherein the method further comprises:
responsive to determining that the common activity corresponds to a dynamic environment, setting the broadcast interval to below a predetermined fast-beacon interval.

17. A computer system, comprising:
a first radio for communicating with a target network node of an ad-hoc network based on a routing table for the ad-hoc network;
a second radio for relaying a data packet transmitted by a neighboring network node toward the data packet's intended recipient, based on the routing table;
a third radio for broadcasting data packets;
a network topology synchronizing module for synchronizing network topology information with a respective network node of the one or more neighboring nodes using the third radio; and
a network-managing module for updating the routing table based on the received network topology information, responsive to detecting a change to a network topology of the ad-hoc network based on the received network topology information.

18. The computer system of claim 17, wherein the network topology information includes one or more of:
node information for a neighboring network node;
routing information for the neighboring network node; and
a routing table.

19. The computer system of claim 17, wherein the network topology synchronizing module is further configured to:
synchronize the network topology information between the local network node and the one or more neighboring nodes via the third radio.

20. The computer system of claim 17, wherein the one or more neighboring nodes are associated with a common activity with the local network node, and wherein the network-managing module is further configured to:
manage a private network associated with the common activity, wherein the private network includes as members the one or more neighboring nodes associated with the common activity.

21. The computer system of claim 20, wherein the method further comprises an authentication module configured to:
authenticate a new network node detected in the ad-hoc network; and
verify that the network node is associated with the common activity; and
wherein the network-managing module is further configured to add the network node to the private network responsive to successfully authenticating and verifying the network node.

22. The computer system of claim 20, wherein the method further comprises a data-communication module configured to determine a broadcast interval based on a policy for the private network.

23. The computer system of claim 22, wherein the data-communication module is further configured to:
responsive to determining that the common activity corresponds to a still environment, setting the broadcast interval to above a predetermined slow-beacon interval.

24. The computer system of claim 22, wherein the data-communication module is further configured to:
responsive to determining that the common activity corresponds to a dynamic environment, setting the broadcast interval to below a predetermined fast-beacon interval.
